(19) United States
(12) Patent Application Publication
(10) Pub. No.: US 2021/0102308 A1
(43) Pub. Date: Apr. 8, 2021

(54) ELECTROCHEMICAL ETCHING

(71) Applicant: PRATT & WHITNEY CANADA CORP., Longueuil (CA)

(72) Inventors: Visal ING, Ste. Julie (CA); Frederic GIRARD, St-Hubert (CA); Pascal BRASSARD, Saint Amable (CA); Jonathan JOHNSON, Sainte-Martine (CA)

(21) Appl. No.: 16/776,719

(22) Filed: Jan. 30, 2020

Related U.S. Application Data
(60) Provisional application No. 62/912,239, filed on Oct. 8, 2019.

(51) Int. Cl. C25F 3/02

(52) U.S. Cl. CPC C25F 3/02

(57) ABSTRACT

A method of adding a feature to a part made of a metal alloy includes wire electric-discharge machining the feature into the part using a wire electrode having a zinc component to create a recast layer. After the step of wire electric-discharge machining the feature, at least some of the recast layer is removed by performing an electrochemical etching process that includes positioning a cathode adjacent the feature and passing current through a portion of the part that contains the feature.

### CROSS-REFERENCE

The present application claims the benefit of priority to U.S. Patent Application No. 62/912,239, filed Oct. 8, 2019, entitled “ELECTROCHEMICAL ETCHING”, and hereby expressly incorporated herein in its entirety.

### TECHNICAL FIELD

The application relates generally to methods and systems for wire electric discharge machining parts and processing the parts after the wire electric discharge machining.

### BACKGROUND

Prior art methods of wire electric discharge machining (wEDM) cut-outs in parts and of validating the resulting parts are known and suitable for their intended purposes. In some applications, such as aerospace applications, in which wEDM may be used usually involve machining relatively expensive parts and labour. Hence, improvements to existing wEDM methods are desirable, especially in the aerospace industry.

### SUMMARY

In an aspect, there is provided a method of adding a feature to a part made of a metal alloy, comprising: wire electric-discharge machining the feature into the part using a wire electrode having a zinc component to create a recast layer, after the step of wire electric-discharge machining the feature, removing at least some of the recast layer by performing an electrochemical etching process that includes positioning a cathode adjacent the feature and passing current through a portion of the part that contains the feature.

In some embodiments, the step of performing the electrochemical etching process includes exposing the recast layer to an electrolyte during the step of passing current through the portion of the part.

In some embodiments, the step of performing the electrochemical etching process includes forming a sulfate radical.

In some embodiments, the forming the sulfate radical is from a sulfate ion.

In some embodiments, the step of performing the electrochemical etching process includes reacting the sulfate radical with water to form sulfuric acid and oxygen.

In some embodiments, the step of performing the electrochemical etching process includes reacting oxygen with a material of the recast layer to form a metal oxide.

In some embodiments, the recast layer includes a nickel base alloy and the step of performing the electrochemical etching process includes reacting oxygen with the nickel base alloy to form a metal oxide.

In some embodiments, the electrolyte includes sulphuric acid.

In some embodiments, the sulphuric acid has a concentration of between 30% to 50% by volume.

In some embodiments, the sulphuric acid has a concentration of between 35% to 45% by volume.

In some embodiments, the method comprises determining a thickness of the recast layer and wherein the step of performing the electrochemical etching process includes selecting a current to pass through the recast layer based on the determined thickness of the recast layer.

In some embodiments, the step of selecting the current includes selecting the current based on an area of the recast layer.

In some embodiments, the method comprises determining an area of the recast layer and wherein the step of selecting the current includes selecting the current from a range of 120 to 135 ampere-minutes per square foot of the area of the recast layer.

In some embodiments, the step of selecting the current includes selecting the current as a direct current.

In some embodiments, the step of passing current through the portion of the part includes making the part an anode and passing the current from the cathode into the anode.

In some embodiments, the method comprises controlling the current to be within a range of 5 to 15 amperes.

In some embodiments, the method comprises controlling the current to be less than 10 amperes.

In another aspect, there is provided a method of adding a feature to a part made of a metal alloy, comprising: wire electric-discharge machining the feature into the part using a wire electrode having a zinc component to create a recast layer having an initial composition make-up including a zinc content and at least one other material content in an outer surface thereof as a result of the wire electric-discharge machining the part feature, and after the step of wire electric-discharge machining the feature, removing at least a portion of the zinc content of the outer surface by performing an electrochemical etching process that includes positioning a cathode adjacent the feature and passing current through a portion of the part that contains the feature.

In some embodiments, the method comprises, after the step of electrochemical etching process, permitting inspection of the part for metallurgical discontinuities.

In some embodiments, the step of performing the electrochemical etching process includes contacting a sulphuric acid to the portion of the part that contains the feature.

### BRIEF DESCRIPTION OF THE DRAWINGS

Reference is now made to the accompanying figures in which:

FIG. 1 is a schematic of a wire electro-discharge machining system;

FIG. 2 is a schematic of a part into which one or more features have been machined using the system of FIG. 1;

FIG. 3 is a schematic of the part in a system for performing electrochemical etching of the part of FIG. 2;

FIG. 4 is a schematic of a part of the system of FIG. 3; and

FIG. 5 is a close-up view of a part to be electrochemically etched, which is an anode in this embodiment, and a cathode of the system of FIG. 3.

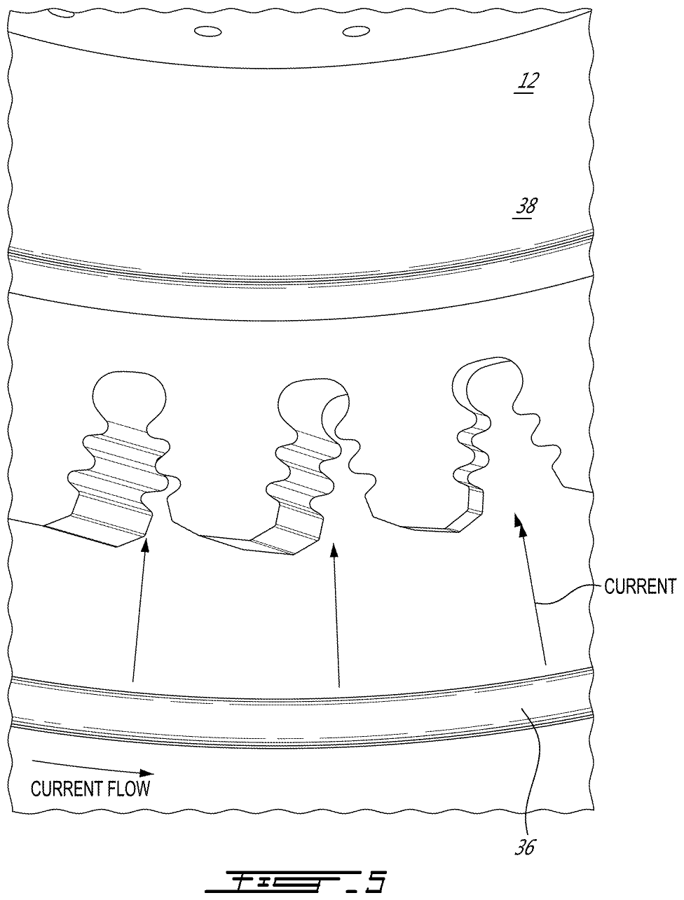

### DETAILED DESCRIPTION

Wire electro-discharge machining (“wire-EDM” or “wEDM”) is a known machining process used to machine parts. Although wire-EDM can be used to machine a variety of parts, in gas turbine engine applications, wire-EDM may for example be used to cut fir-tree slots in turbine discs. Typically, wire-EDM uses a wire electrode to cut through the metal part. When the wire electrode cuts through metal there is a localized melting of the base metal, which then re-solidifies. The resulting re-solidified layer is referred to as the “recast layer”.

Metal alloys (including but not limited to nickel alloys) sometimes present metallurgical discontinuities (referred to as “segregation”), which are undesirable and often result in a part having such discontinuities being discarded. Accordingly, an inspection of each part is conducted to ensure that no such segregation has occurred. However, when the part has been machined by wire-EDM, the presence of the recast layer can mask segregations in the metal. As such, the recast layer can sometimes render segregations undetectable using at least some inspection techniques.

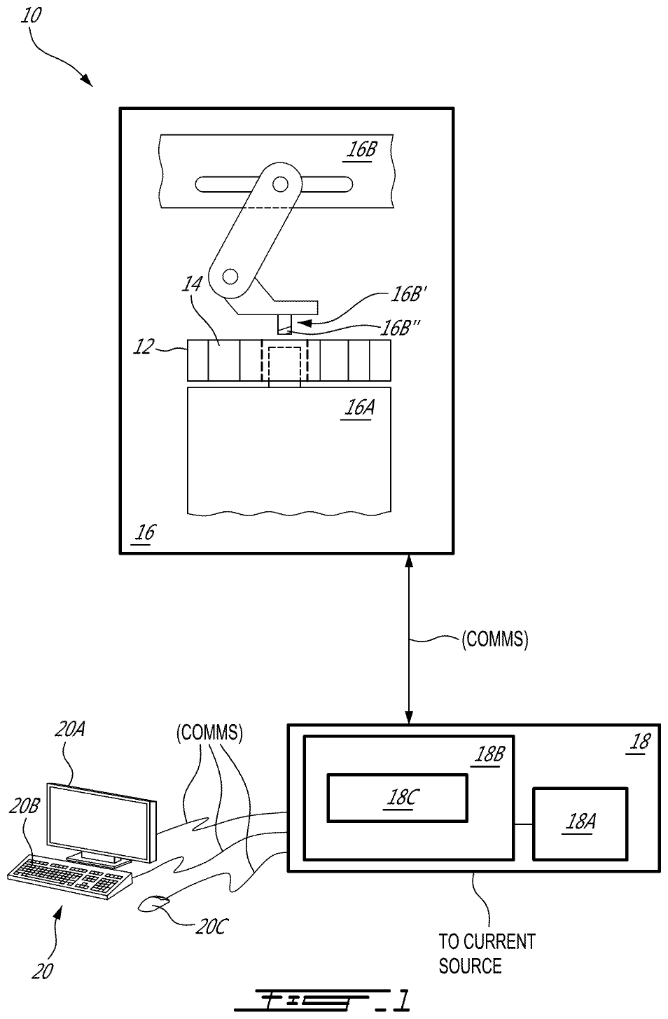

FIG. 1 illustrates a system 10 for machining, in a part 12, in this case a turbine disc, a plurality features 14. In this embodiment the part 12 is a turbine disc and the features 14 are cut-outs, and more particularly fir-tree shaped slots 14. In other embodiments, the part 12 may be a different part, such as for example a compressor disc, an integrally bladed disc, or other part which is not necessarily a part to be used in an aircraft gas turbine engine. In other embodiments, one or more of the features 14 may be different, such as for example one or more different cut-outs. Stated otherwise, the methods of the present technology may be applied for manufacturing parts and cut-outs different from the turbine disc 12 and the slots 14.

In the present embodiment, the system 10 includes a wire-electric-discharge-machining (wEDM) machine 16. The wEDM machine 16 may include a securement assembly 16A configured to removably engage, and removably engaging as shown in FIG. 1, the part 12 to be machined, to the wEDM machine 16. The wEDM machine 16 may also include a wEDM machining assembly 16B configured to machine the part 12 using a wEDM process. According to one embodiment of the present technology, the wEDM machining assembly 16B includes a wire electrode 16B′ having a zinc component 16B″. The wire electrode 16B′ is used by the wEDM machining assembly 16B to cut, using wEDM, the feature(s) 14 into the part 12. The wEDM machine 16, including the securement assembly 16A and the wEDM machining assembly 16B, may be conventional. The wEDM machine 16 and its possible components are therefore not shown herein in detail and are not described herein in detail. The wEDM machine 16 may be different than shown, so long as it is capable of providing the functionality and executing the steps described herein.

Still referring to FIG. 1, the system 10 further includes a controller 18 operatively connected to the wEDM machine 16 and to a conventional input-output system 20 that may be used to configure and/or operate the controller 18 and/or the wEDM machine 16. In this embodiment the controller 18 may be any suitable controller, and may be for example a conventional computer selected and configured using conventional parts and programming techniques to provide for the functionality described herein. As a non-limiting example, to this end in the present embodiment, the controller 18 includes a processor 18A, which may include for example one or more conventional central processing units (CPU(s)), and a non-transitory memory 18B, which may include for example a hard drive. The non-transitory memory 18B stores thereon processor-executable instructions 18C and is operatively connected to the processor 18A, such as via a suitable memory bus for example, to allow the processor 18A to execute the processor-executable instructions 18C. The processor-executable instructions 18C may be created using conventional programming methods, such that when executed, the processor-executable instructions 18C cause the controller 18 to operate the wEDM machine 16 to cut the features 14 into the part 12.

The input-output system 20 in this embodiment may be any suitable input-output system, which may be for example selected and configured using conventional parts and programming techniques to provide for the functionality described herein. As a non-limiting example, to this end in the present embodiment, the input-output system 20 includes a conventional monitor 20A for displaying information thereon, such as data received from the controller 18 for example, and a conventional keyboard 20B and mouse 20C for entering data into and interacting with the controller 18. It is contemplated that any other input-output system 20 may be used and/or that the input-output system 20 may be part of the controller 18 and/or that the input-output system 20 may be omitted in some embodiments, so long as the functionality of the system 10 as described herein is provided. Stated more broadly, the system 10 may have more or fewer of the components as described herein, and/or different embodiments of the components described herein, to suit each particular embodiment of the methods of the present technology that are described herein.

The particular combination of operating connections of the controller 18 and/or the input-output system 20 to one or more of the components of the system 10, as may be needed given each particular embodiment and application thereof, may be selected depending on the particular embodiment and extent of automation of the system 10 for example, and may be implemented using any suitable conventional parts and communication protocols. As a non-limiting example, in some embodiments, the communications of the controller 18 to the other components of the system 10 may be wireless, wired, or a combination of wireless and wired. The communications of the controller 18 to the other components of the system 10 in the present embodiment are shown with respective arrows labeled (COMMS).

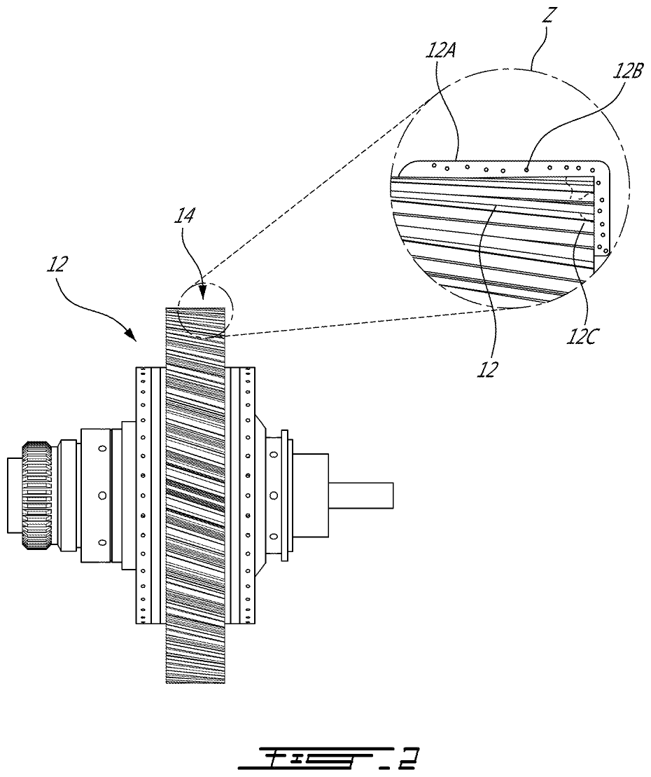

FIG. 2 shows the part 12 having the features 14 machined therein using the wEDM machine 16, and more particularly using the wire electrode 16B′ having the zinc component 16B″. As shown in zoom (Z), in some cases, the wEDM process executed using the wire electrode 16B′ may leave a recast layer 12A along at least parts of surfaces machined using the wEDM process. In embodiments such as the present when a wire electrode 16B′ having a zinc component 16B″ is used, the recast layer 12A may include therein traces of zinc 12B deposited from the zinc component 16B″ during the wEDM process.

Further as shown in FIG. 2, sometimes, such machined parts 12, for example when made from metal alloys (including but not limited to nickel alloys) sometimes present metallurgical discontinuities, or “segregations” 12C. Depending on the application of each given part 12, the presence of segregations 12C may render the part 12 unsuitable for its intended application(s). For such applications, an inspection of the part 12 may be conducted to ensure that no such segregation 12C are present. However, the presence of the recast layer 12A may mask and thereby render undetectable one or more segregations 12C, thus rendering the inspection process less reliable. The present technology accordingly provides an electrochemical etching process that may remove at least some, and in some cases all, of the recast layer 12A, and/or may remove at least some, and in some cases all, of the zinc deposits 12B from the part 12.

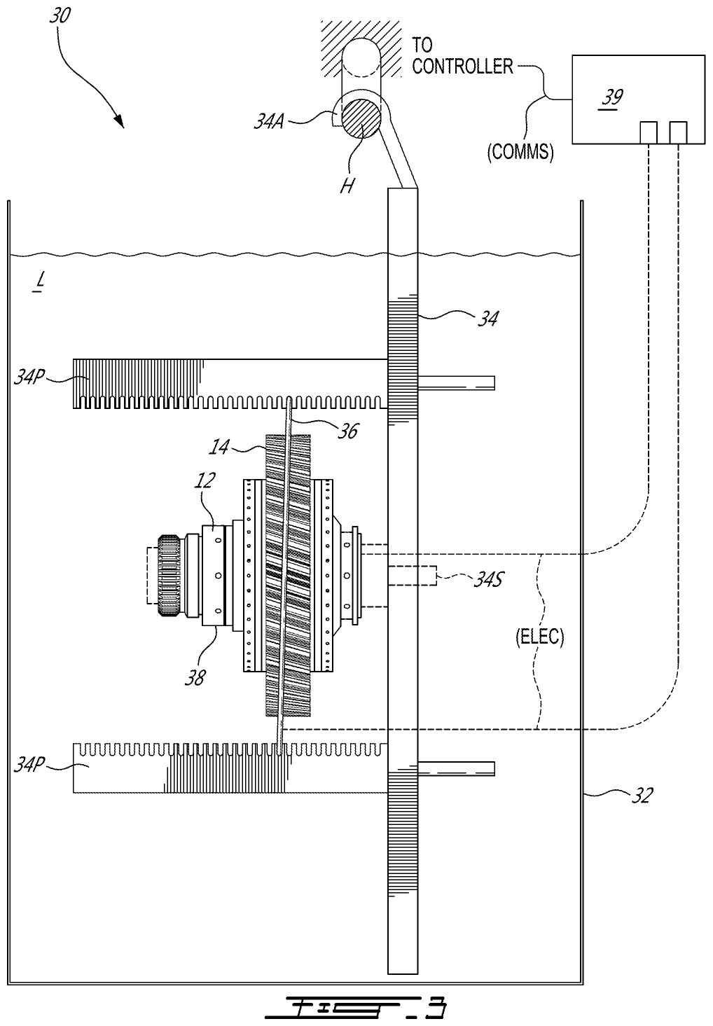

Referring to FIG. 3, for executing the electrochemical etching process, the present technology provides a cathode-anode system 30. The cathode-anode system 30 includes a bath/volume 32 of a suitable liquid electrolyte (L), a sulphuric acid in this non-limiting embodiment. In this embodiment, the sulphuric acid is concentrated 40% by volume. In some embodiments, the sulphuric acid is concentrated in a range of 35 to 50% by volume. In some embodiments, the sulphuric acid is concentrated in a range of 35% to 45% by volume. In some such embodiments, the electrolyte (L) may include water (H2O), for example as a remainder of the volume. While such concentrations may provide advantages in some applications, yet other concentrations and/or electrolytes (L) may be used to suit each particular material and/or composition of the recast layer 12A for example. The bath 32 may be of conventional construction and is sized to receive the part 12 therein. For positioning the part 12 in the bath 32, the cathode-anode system 30 includes a rack 34 sized and configured to position at least the portion(s) of the part 12 having the recast layer 12A to be removed in the bath 32. In this embodiment, the rack 34 is titanium, or titanium plated, and this may provide some advantages in some cases, however other suitable non-reactive (to the electrochemical etching process described herein) materials may also be used. In this embodiment the rack 34 includes a hook 34A at a top portion thereof which is sized to be hung onto a suitable corresponding hook (H) or other suitable member positioned for example over the bath 32 as shown. While providing advantages in some applications, another securement feature may be used instead of or in combination with the hook 34A.

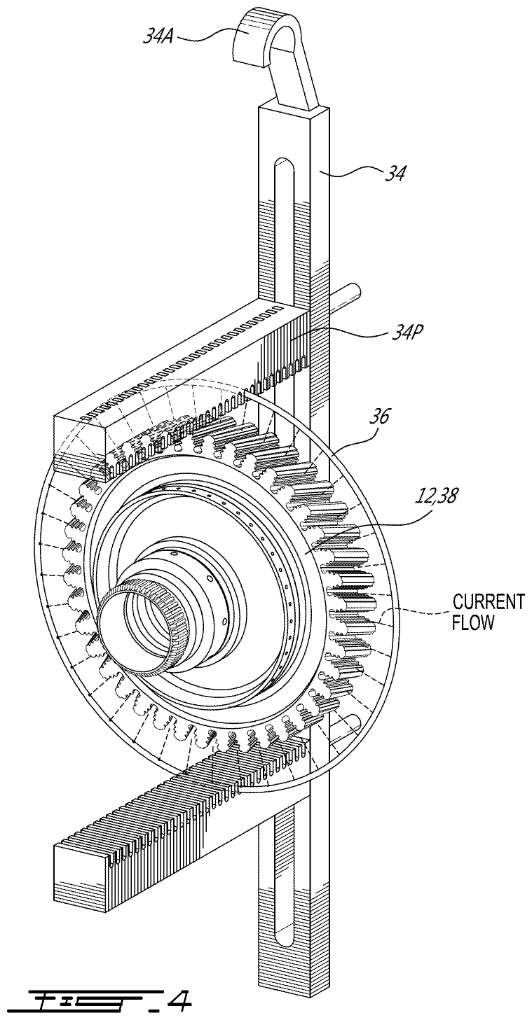

The cathode-anode system 30 further includes a cathode 36 and an anode 38 connected to the rack 34. In the present embodiment, the part 12 is made the anode 38 by a corresponding suitable electrical connection (ELEC) thereto. The cathode 36 is made of a nickel alloy; while this may provide some advantages, other suitable materials may be used. The cathode 36 is spaced from the part/anode 12, 38 as shown in FIGS. 3 and 4, so as to direct current flow through the portion(s) of the part 12 having the recast layer 12A to be removed. In this embodiment, the recast layer 12A may be present in the vicinity of the fir-tree shaped slots/features 14, and therefore the cathode 36 is positioned proximate the respective portions having the features 14, and in this embodiment more particularly the outer periphery of the part 12. In this embodiment, the cathode 36 is shaped to conform to the corresponding portion(s) of the part 12 having the feature(s) 14. Since in this embodiment the part 12 is a circular disc 12, the cathode 36 is circular and therefore is placed at an equal distance all around (360 degrees around) the outer periphery of the disc 12. In cases where the part 12 is hexagonal for example, at least part of the cathode 36 may be hexagonal. While this provides advantages in some applications, such as for example an even distribution of the current throughout the recast layer 12, it is contemplated that the cathode 36 may have a different shape, such as for example a shape conforming to at least a part of the portion(s) of the part 12 having the recast layer 12A.

In this embodiment, the cathode 36 is placed at 1 inch away from the outer diameter of the disc 12. In some embodiments, the cathode 36 is placed in a range of ⅜ of an inch to 2.5 inches away from the outer diameter of the disc 12. While this provides advantages in some applications, it is contemplated that the cathode 36 may be placed at other distances in at least some applications. In this embodiment to provide some advantages such as efficiency and although need not be the case in other embodiments, the cathode 36 is positioned relative to the part 12/anode 38 to pass current through, and as shown in FIGS. 3 and 4, in plane with, the portion(s) of the part 12 having the recast layer 12A, in a direction selected to remove the recast layer 12A from the part 12. In an aspect, the present non-limiting placement of the cathode 36 concentrates the current on the recast layer 12A. More broadly, the cathode 36 may be dimensioned to correspond/conform to the portion(s) of the part 12 having the recast layer 12A when disposed proximate the portion(s).

Still referring to FIG. 3, a suitable structure 34S, schematically shown in FIG. 3, may be used to secure the part 12 in between the cathode 36 and the anode 38. In this embodiment the cathode 36 is held in place by two members, in this embodiment plastic members 34P, connected to the rack, but other holders and/or materials therefor may also be used. Any suitable connection may be used to secure the cathode 36 and therefore this aspect is not described herein in detail. Referring to FIG. 3, a suitable source of electrical current, referred to herein as a current source 39, at respective terminals thereof is electrically connected to respective ones of the cathode 36 and the anode 38 using any suitable corresponding electrical connections (ELEC). The current source 39 may include therein one or more components selected to provide for the current supply and control as described herein. The current source 39 and the one or more components thereof be conventional and are therefore not described in detail herein. As shown at the label (COMMS), the current source 39 may be operatively connected to the controller 18 (FIG. 1) to be controlled and operated thereby to provide for the functionality described in this document.

The cathode-anode system 30 may be used to perform a method of etching the part 12 using an electrochemical process described next, by applying current as shown in the figures and described above. The electrochemical process may involve the following steps:

At the Anode (Part)
The sulphate radical is attracted to the anode where it gives up two electrons and forms oxygen and sulfuric acid molecules.

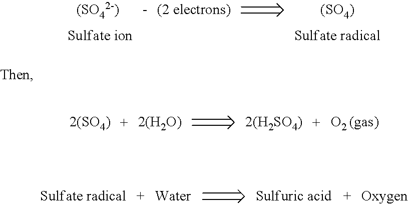

In this non-limiting embodiment, since the recast layer includes a nickel base alloy, the oxygen forms bubbles that rise into the air, but some of the oxygen reacts with the nickel base alloy to form a metal oxide that (referred to herein as “smut”). In some embodiments where the recast layer may include a different metal, the oxygen may react with the different metal to form a corresponding different metal oxide.

At the Cathode
In an embodiment, a direct current is applied to the cell and the cathode is negative and the anode (part) is positive. In this embodiment, the hydrogen ions migrate to the cathode where they pick up an electron and becomes a molecule of hydrogen atom. Two atoms then attach together and become a molecule of hydrogen gas.

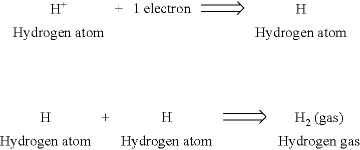

In this method comprising electrochemically etching the part 12, current density may be selected by determining a thickness of material (e.g. the thickness of the recast layer 12A) to remove and selecting the current density based on the determined thickness. In some embodiments, an area of material (e.g. the thickness of the recast layer 12A) to remove may be determined and the current density may be selected based on the determined area. In the present embodiment, the current density may be selected to be 125 Ampere-minutes per square foot of the area of the recast layer 12A to be anodized. In some embodiments, the current density may be selected to be in a range of 120 to 135 Ampere-minutes per square foot of the area of the recast layer 12A to be anodized. In some such embodiments, the current may be selected as a direct current.

While such current configurations may provide advantages in some embodiments, it is contemplated that other current densities may be used. In some embodiments, to remove at least at least a substantial portion of the recast layer 12A, a cycle time may be selected to be between 30 and 60 minutes, and may be for example 45 minutes, and an amperage may be selected to be for example in a range of 5 to 15 Amperes, and in some embodiments may be less than 10 Amperes. With these parameters, the cathode 36 may allow for even removal of the recast layer 12A in complex geometry features, such as the fir-tree cut-outs 14. In some embodiments, the present method may allow to remove a thickness of the recast layer 12A that may be in a range of 1/10,000 of an inch to 2/10,000, and may provide advantages relative to at least some prior art methods for removing recast layers 12A in this range. It is contemplated that the methods of the present technology may likewise be used for removing other thicknesses of recast layer(s).

More broadly in view of the above, the present technology also provides a method of adding a feature (e.g. 14) to a part (e.g. 12) made of a metal alloy, which may include wire electric-discharge machining the feature into the part using a wire electrode having a zinc component to create a recast layer having an initial composition make-up including a zinc content and at least one other material content in an outer surface thereof as a result of the wire electric-discharge machining the part feature, and after the step of wire electric-discharge machining the feature, removing at least a portion of the zinc content of the outer surface by performing an electrochemical etching process that includes positioning a cathode adjacent the feature and passing current through a portion of the part that contains the feature.

In some such embodiments, the method may include, after the step of electrochemical etching process, permitting inspection of the part for metallurgical discontinuities. As an example, inspection of the part for metallurgical discontinuities may be performed using conventional metallurgical inspection methods. As seen above, in some embodiments, the step of the method of performing the electrochemical etching process may include contacting a sulphuric acid to the portion of the part that contains the feature. In the above system, this is done by submerging the part; however, it is contemplated that other ways of contacting a sulphuric acid to the portion of the part that contains the feature may be used.

The above description is meant to be exemplary only, and one skilled in the art will recognize that changes may be made to the embodiments described without departing from the scope of the technology disclosed. For example, while the present methods and systems have been described with respect to wEDM processes leaving a recast layer, it is contemplated that they may be applied to other processes for creating cut-outs or other features in various parts that may create a recast layer, and more particularly for example a recast layer made of a metal alloy, such as a nickel alloy, and having zinc deposits therein. As another example, while the present methods and systems have been described with respect to a turbine disc 12, the methods and systems may also be applied to other parts, including compressor discs, integrally bladed rotors, or yet other parts which may or may not have aircraft applications. As another example, while the current may be passed from the cathode into the anode/part 12, in some embodiments the current may be passed in the opposite direction, before or after, or instead of the first-mentioned direction. Still other modifications which fall within the scope of the present technology will be apparent to those skilled in the art, in light of a review of this disclosure.

1. A method of adding a feature to a part made of a metal alloy, comprising:
wire electric-discharge machining the feature into the part using a wire electrode having a zinc component to create a recast layer,
after the step of wire electric-discharge machining the feature, removing at least some of the recast layer by performing an electrochemical etching process that includes positioning a cathode adjacent the feature and passing current through a portion of the part that contains the feature.

2. The method of claim 1, wherein the step of performing the electrochemical etching process includes exposing the recast layer to an electrolyte during the step of passing current through the portion of the part.

3. The method of claim 1, wherein the step of performing the electrochemical etching process includes forming a sulfate radical.

4. The method of claim 3, wherein the forming the sulfate radical is from a sulfate ion.

5. The method of claim 3, wherein the step of performing the electrochemical etching process includes reacting the sulfate radical with water to form sulfuric acid and oxygen.

6. The method of claim 1, wherein the step of performing the electrochemical etching process includes reacting oxygen with a material of the recast layer to form a metal oxide.

7. The method of claim 1, wherein the recast layer includes a nickel base alloy and the step of performing the electrochemical etching process includes reacting oxygen with the nickel base alloy to form a metal oxide.

8. The method of claim 1, wherein the electrolyte includes sulphuric acid.

9. The method of claim 8, wherein the sulphuric acid has a concentration of between 30% to 50% by volume.

10. The method of claim 9, wherein the sulphuric acid has a concentration of between 35% to 45% by volume.

11. The method of claim 1, comprising determining a thickness of the recast layer and wherein the step of performing the electrochemical etching process includes selecting a current to pass through the recast layer based on the determined thickness of the recast layer.

12. The method of claim 11, wherein the step of selecting the current includes selecting the current based on an area of the recast layer.

13. The method of claim 11, comprising determining an area of the recast layer and wherein the step of selecting the current includes selecting the current from a range of 120 to 135 ampere-minutes per square foot of the area of the recast layer.

14. The method of claim 11, wherein the step of selecting the current includes selecting the current as a direct current.

15. The method of claim 1, wherein the step of passing current through the portion of the part includes making the part an anode and passing the current from the cathode into the anode.

16. The method of claim 1, comprising controlling the current to be within a range of 5 to 15 amperes.

17. The method of claim 1, comprising controlling the current to be less than 10 amperes.

18. A method of adding a feature to a part made of a metal alloy, comprising:
wire electric-discharge machining the feature into the part using a wire electrode having a zinc component to create a recast layer having an initial composition make-up including a zinc content and at least one other material content in an outer surface thereof as a result of the wire electric-discharge machining the part feature, and
after the step of wire electric-discharge machining the feature, removing at least a portion of the zinc content of the outer surface by performing an electrochemical etching process that includes positioning a cathode adjacent the feature and passing current through a portion of the part that contains the feature.

19. The method of claim 18, comprising after the step of electrochemical etching process, permitting inspection of the part for metallurgical discontinuities.

20. The method of claim 18, wherein the step of performing the electrochemical etching process includes contacting a sulphuric acid to the portion of the part that contains the feature.
